(19) United States
(12) Patent Application Publication
(10) Pub. No.: US 2014/0059312 A1
(43) Pub. Date: Feb. 27, 2014

(54) RECORDING MEDIUM, COMPUTER, AND INFORMATION PROCESSING SYSTEM

(71) Applicant: FUJITSU LIMITED, Kawasaki-shi (JP)

(72) Inventor: Kohei UNO, Shizuoka (JP)

(21) Appl. No.: 13/921,528

(22) Filed: Jun. 19, 2013

(30) Foreign Application Priority Data
Aug. 27, 2012 (JP) 2012-186317

(51) Int. Cl. G06F 3/06

(52) U.S. Cl. CPC G06F 3/0655; G06F 3/067; G06F 3/0619
USPC 711/162

(57) ABSTRACT

A non-transitory computer-readable recording medium storing a program causing a processor to execute a process, the process includes identifying a second virtual machine in charge of storing data onto a storage in accordance with a hash value that is calculated from a key and a hash function, the key corresponding to the data that is to be stored on the storage and is placed on a first virtual machine from among a plurality of virtual machines running in a computer and the hash function commonly used by the plurality of virtual machine; storing the data on the storage using the first virtual machine when the second virtual machine matches the first virtual machine; and performing a control operation so that the first virtual machine does not store the data onto the storage when the second virtual machine fails to match the first virtual machine.

### CROSS-REFERENCE TO RELATED APPLICATION

This application is based upon and claims the benefit of priority of the prior Japanese Patent Application No. 2012-186317, filed on Aug. 27, 2012, the entire contents of which are incorporated herein by reference.

### FIELD

The embodiments discussed herein are related to a recording medium, a computer, and an information processing system.

### BACKGROUND

A user of a physical computer (also referred to as a physical machine or a physical host) causes a plurality of virtual computers (also referred to as virtual machines or virtual hosts) to run on the physical computer. Software, such as an operating system (OS) and applications, is executed on each virtual machine. The physical machine executes software that manages a plurality of virtual machines. For example, by executing software called a hypervisor, the physical machine allocates processing power of a central processing unit (CPU) and a storage area of a random-access memory (RAM) as computing resources to a plurality of virtual machines.

Occasionally, data may be distributed across a plurality of virtual machines. Distributing data may increase a data access speed. A technique called key-value store (KVS) may be used to distribute data. In KVS, a key is attached to data (value), and a pair of key and value is placed at any node (such as a virtual machine). To access stored data, the key is specified. By storing data on different nodes in accordance with keys, the data is distributed across the nodes. In a disclosed related art technique, a copy of the data of a given node is placed at an adjacent node as well for redundancy so that the nodes are hardened against node failure.

In another related art technique, a system includes an execution apparatus and a plurality of backup apparatuses. Database (DB) data is placed on a main memory of the execution apparatus, and if the system shuts down, the DB data is distributed and held on storage devices coupled to the backup apparatuses. In accordance with the related art, the execution apparatus determines a range of the DB data to be held by each storage device and then instructs the backup apparatuses to store the DB data accordingly.

Data may be distributed on a plurality of virtual machines using KVS, and copies of the data may be held on the plurality of different virtual machines for redundancy. In an operation of a virtual machine, a resource allocated to the virtual machine may be released if the virtual machine shuts down. The data held by the released resource may disappear. For this reason, the data, if redundantly stored, may be deleted. For example, all the virtual machines holding the data thereon may malfunction at the same time, and may then be forced to shut down and the data may be recreated. Copies of the data are desirably stored on storage devices for backup.

In such a case, however, how to obtain backup data efficiently becomes a concern. For example, a plurality of virtual machines holding the same data thereon may make copies of the data and then store the copies onto the storage devices thereof. However, if the plurality of virtual machines store the same data redundantly, data transfer gives rise to an increase in communication costs and processing costs, leading to an inefficient operation.

The related art techniques such as those are disclosed Japanese Laid-open Patent Publication No. 2009-543237 and Japanese Laid-open Patent Publication No. 2010-134583.

### SUMMARY

According to an aspect of the invention, a non-transitory computer-readable recording medium storing a program causing a processor to execute a process, the process includes identifying a second virtual machine in charge of storing data onto a storage in accordance with a hash value that is calculated from a key and a hash function, the key corresponding to the data that is to be stored on the storage and is placed on a first virtual machine from among a plurality of virtual machines running in a computer and the hash function commonly used by the plurality of virtual machine; storing the data on the storage using the first virtual machine when the second virtual machine matches the first virtual machine; and performing a control operation so that the first virtual machine does not store the data onto the storage when the second virtual machine fails to match the first virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an information processing system of a first embodiment;

FIG. 2 illustrates an information processing system of a second embodiment;

FIG. 3 illustrates a hardware configuration of an execution server of the second embodiment;

FIG. 4 illustrates an execution example of a virtual machine of the second embodiment;

FIG. 5 illustrates a software configuration of the second embodiment;

FIG. 6 illustrates an example of an assignment range of a hash value of the second embodiment;

FIGS. 7A, 7B and 7C illustrate an example of KVS of the second embodiment;

FIGS. 8A, 8B and 8C illustrate an example of a management table of the second embodiment;

FIG. 9 illustrates an example of a backup table of the second embodiment;

FIGS. 10A and 10B illustrate an example of communication data of the second embodiment;

FIGS. 11A and 11B illustrate a processing example of a function of the second embodiment;

FIG. 12 is a flowchart illustrating a session update process of the second embodiment; and

FIG. 13 is a flowchart illustrating a backup process of the second embodiment.

### DESCRIPTION OF EMBODIMENTS

Embodiments are described with reference to the drawings.

### First Embodiment

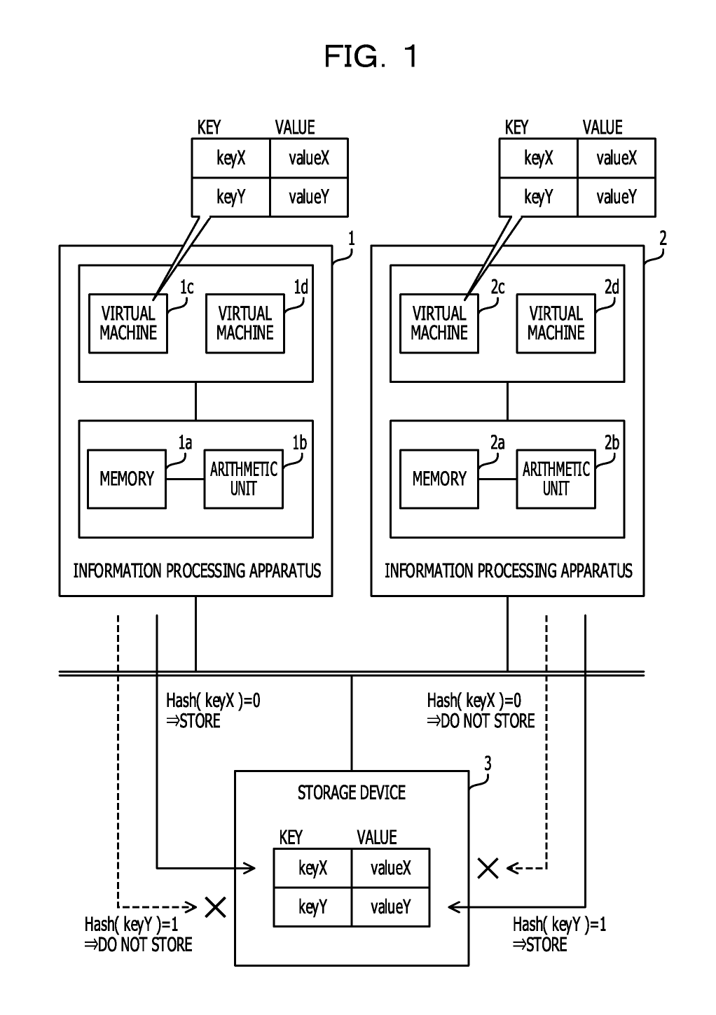

FIG. 1 illustrates an information processing system of a first embodiment. The information processing system of the first embodiment includes information processing apparatuses 1 and 2 and a storage device 3. The information processing apparatuses 1 and 2 and the storage device 3 are coupled to each other via a network. The information processing apparatuses 1 and 2 allow a virtual machine to run thereon. The information processing system places data associated with keys on a plurality of virtual machines corresponding to the keys. The storage device 3 stores the data placed at the plurality of virtual machines. For example, the storage device 3 includes a non-volatile storage device. The data stored on the non-volatile storage device in the storage device 3 serves as a backup. The storage device 3 is included in one of the information processing apparatuses 1 and 2.

The information processing apparatus 1 includes a memory 1a, an arithmetic unit 1b, and virtual machines 1c and 1d.

The memory 1a is a volatile or non-volatile memory storing data. The memory 1a may include a random-access memory (RAM) or a hard disk drive (HDD). A hypervisor executed by the information processing apparatus 1 allocates a portion of the storage area of the memory 1a to the virtual machine 1c as a resource. The hypervisor also allocates another portion of the storage area of the memory 1a to the virtual machine 1d as a resource.

The arithmetic unit 1b is a processor that executes an information process of the information processing apparatus 1. The arithmetic unit 1b may be a central processing unit (CPU). Part of the processing power of the arithmetic unit 1b is allocated to the virtual machines 1c and 1d as a computing resource. For example, the hypervisor allocates to the virtual machine 1c a part of a plurality of time slices into which an available time of the arithmetic unit 1b is time-segmented. The hypervisor allocates another part of the time slices to the virtual machine 1d.

The information processing apparatus 1 may be a computer including the memory 1a (memory) and the arithmetic unit 1b (processor).

Each of the virtual machines 1c and 1d is a virtual computer that operates using the resources allocated from the memory 1a and the arithmetic unit 1b. The virtual machines 1c and 1d may execute software including an operating system (OS) and applications. The virtual machines 1c and 1d distribute data used in a process of the software across a plurality of virtual machines through the KVS technique. For example, the virtual machine 1c holds, as a combination of key and value, (keyX, valueX), and (keyY, valueY). The value means data. The combination of key and value may be referred to as data.

The information processing apparatus 2 includes a memory 2a, an arithmetic unit 2b, and virtual machines 2c and 2d. The memory 2a is identical to the memory 1a, and the discussion thereof is omitted. The arithmetic unit 2b is identical to the arithmetic unit 1b and the discussion thereof is omitted.

Each of the virtual machines 2c and 2d is a virtual computer that operates using the resources allocated from the memory 2a and the arithmetic unit 2b. As the virtual machines 1c and 1d, the virtual machines 2c and 2d may also execute software including an operating system (OS) and applications. The virtual machines 2c and 2d distribute data used in a process of the software across a plurality of virtual machines through the KVS technique.

In the first embodiment, redundancy is provided by placing the same data at two virtual machines. A copy of the data placed on the virtual machine 1c is also placed on the virtual machine 2c. More specifically, (key, value)=(keyX, valueX) and (keyY, valueY) are also placed on the virtual machine 2c so that data redundancy is provided on the virtual machines 1c and 2c. The data with redundancy is referred to as redundancy data. To store the redundancy data on the storage device 3, the arithmetic units 1b and 2b perform the following operation.

The arithmetic unit 1b calculates a hash value “Hash(keyX)” from a key “keyX” corresponding to data “valueX” placed on the virtual machine 1c and a hash function (function Hash, for example) commonly used by the virtual machines 1c and 2c. In accordance with the hash value “Hash(keyX)”, the arithmetic unit 1b identifies a virtual machine that is in charge of storing the data onto the storage device 3. The same operation applies to the data “valueY”.

The hash function is a function that makes substantially uniform the probability of occurrence of each hash value output in response to an input. For example, the hash function Hash calculates a probability of about 1/2 of “0” or “1” in response to a key. In such a case, a virtual machine in charge of storing the data is substantially uniformly allocated to the virtual machines 1c and 2c in accordance with the hash value “0” or “1” in response to the key.

When the virtual machine in charge matches the virtual machine 1c, the arithmetic unit 1b performs a control operation using the virtual machine 1c to store the data onto the storage device 3. The hash function Hash is so set that if the hash value is “0”, the virtual machine 1c is in charge, and that if the hash value is “1”, the virtual machine 2c is in charge. Thus, if “Hash(keyX)=0, the virtual machine 1c is in charge. The arithmetic unit 1b may store “valueX” on the storage device 3 using the virtual machine 1c (may also store a combination of “valueX” and “keyX”). The arithmetic unit 2b perform an operation similar to the operation of the arithmetic unit 1b, thereby performing a control operation so that the virtual machine 2c does not store “valueX” on the storage device 3.

If the virtual machine in charge fails to match the virtual machine 1c, the arithmetic unit 1b performs the control operation so that the virtual machine 1c does not store the data on the storage device 3. For example, if “Hash(keyY)=1”, the virtual machine 2c is in charge. The arithmetic unit 1b performs the control operation so that the virtual machine 1c does not store “valueY” on the storage device 3. The arithmetic unit 2b performs the same operation as the arithmetic unit 1b, and may thus store the “valueY” onto the storage device 3 using the virtual machine 2c (may also store a combination of the “valueY” and the “keyY”).

The arithmetic unit 1b in the information processing apparatus 1 may thus identify a virtual machine in charge of storing the data onto the storage device 3 in accordance with the hash value that is calculated from the key corresponding to the data placed on the virtual machine 1c running in the information processing apparatus 1 and from the hash function commonly used by the plurality of virtual machines. If the virtual machine in charge matches the virtual machine 1c, the arithmetic unit 1b performs the control operation to store the data on the storage device 3 using the virtual machine 1c. If the virtual machine in charge fails to match the virtual machine 1c, the arithmetic unit 1b performs the control operation so that the virtual machine 1c does not store the data onto the storage device 3.

The data backup is efficiently performed in this way. Since one of the plurality of virtual machines with the redundancy data placed thereon is in charge of storing the data onto the storage device 3, communication costs and processing costs involved in data transfer are reduced in comparison with the case in which the plurality of virtual machines store the same data by multiple times. A cost incurred by writing the same data onto the storage device 3 twice is also saved. Each virtual machine may determine whether the virtual machine itself is in charge or not in an autonomous fashion. The data backup is performed without separately arranging a device that specifies which virtual machine is in charge. Responsibility of data storage is generally uniformly shared by the plurality of virtual machines. Process load involved in the data storage may thus be substantially uniformly distributed among the plurality of virtual machines with the redundancy data placed thereon.

In order to place data on the virtual machines 1c and 1d in a redundant fashion, a similar method may be employed to determine which of the virtual machines 1c and 1d is to be in charge. In other words, the information process of the first embodiment is effective even if the number of information processing apparatuses is one.

The information process of the first embodiment may be executed when the arithmetic units 1b and 2b perform programs stored on the memories 1a and 2a. In such a case, the program may be executed using resources allocated to the virtual machines 1c, 1d, 2c, and 2d. The resources may be pre-allocated to the virtual machines 1c, 1d, 2c, and 2d so that the program is executed thereon. The program may be executed using a resource other than the resources allocated to the virtual machines 1c, 1d, 2c, and 2d. For example, a hypervisor may perform the above information process.

### Second Embodiment

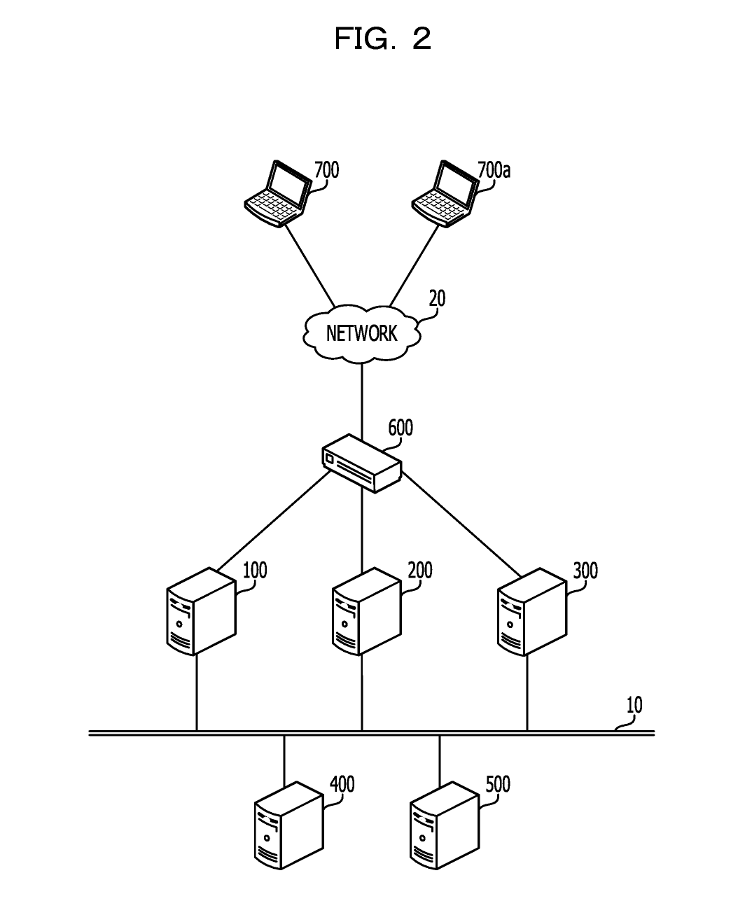

FIG. 2 illustrates an information processing system of a second embodiment. The information processing system of the second embodiment includes execution servers 100, 200 and 300, a storage server 400, a management server 500, a load balancer 600, and clients 700 and 700a. The execution servers 100, 200 and 300, the storage server 400, and the management server 500 are coupled to a network 10. The execution servers 100, 200 and 300 are coupled to the load balancer 600. The load balancer 600 and the clients 700 and 700a are coupled to a network 20.

The networks 10 and 20 are local-area networks (LANs). The networks 10 and 20 may be wide-area networks (WANs), such as the Internet.

The execution servers 100, 200 and 300 are computers that run virtual machines. The virtual machines running on the execution servers 100, 200 and 300 perform applications for use in transactions of a user. The user uses the application using the clients 700 and 700a. The virtual machine has a Web server function, and then provides the user with the application as a Web application. The user uses the Web application by operating a Web browser executed by the clients 700 and 700a. A plurality of virtual machines on the execution servers 100, 200 and 300 distribute load thereon by providing the same Web application on a given user.

The storage server 400 is a server computer that stores a backup of data handled by a virtual machine. The storage server 400 includes a non-volatile storage device. If data is stored on the storage device, the data is maintained if power supplying is interrupted. The storage server 400 may be a network attached storage (NAS). The network 10 may be a storage area network (SAN), and a storage device communicating with the execution servers 100, 200 and 300 via a fiber channel (FC) may be used for the storage server 400.

The management server 500 is a server computer that controls a startup and a shutdown of a virtual machine running on the execution servers 100, 200 and 300. For example, an administrator may operate the management server 500, thereby causing the execution servers 100, 200 and 300 to newly start a virtual machine. The administrator may shut down the virtual machine.

The load balancer 600 is a relay apparatus that distributes requests for a plurality of virtual machines. For example, when a virtual machine on the execution server 100 and a virtual machine on the execution server 200 provides the same Web application, the load balancer 600 receives from the clients 700 and 700a requests addressed at virtual Internet protocol (IP) addresses corresponding to the Web applications. The load balancer 600 distributes the requests to any of the virtual machines on the execution servers 100 and 200. The method of distribution may a round-robin method, for example. Alternatively, a distribution destination may be determined in view of the number of connections established on each virtual machine and a response time of each virtual machine.

The clients 700 and 700a are client computers operated by the users. As described above, the clients 700 and 700a execute the Web browser. For example, the user operates a graphic user interface (GUI) provided by the Web application on the Web browser. In this way, the user may transmit the request to the Web application, or check a response in reply to the request.

Some of the Web applications operate on condition that a session established with the Web browser is maintained. For this reason, the load balancer 600 has a function of distributing a request from the same client to the same server in a fixed fashion, and causing the same server to maintain the session. This function is referred to as a sticky function.

The load balancer 600 may now distribute a request from a Web browser on the client 700 to a virtual machine on the execution server 100, for example. Once the load balancer 600 determines the distribution destination of the request from the client 700, the load balancer 600 transfers a subsequent request from the client 700 to the virtual machine of the distribution destination. As long as the request of the Web browser on the client 700 is transferred to the same virtual machine on the execution server 100, the session is maintained, and the function of the Web application is normally used.

Persistence time of the sticky function may be limited on the load balancer 600. For example, the persistence time may be as short as 1 minute. The session may time out while the user views the Web browser, and the request from the client 700 may be redistributed to another virtual machine. An operation to reestablish a session to use the Web application (such as login) is to be performed, and this inconveniences the user in the use of the Web application. The same inconvenience might occur when the sticky function is not available on the load balancer 600.

Each virtual machine on the execution servers 100, 200 and 300 has a function of holding and sharing information about session (hereinafter referred to as session information). Even if the request is redistributed to another virtual machine, the session is maintained by obtaining the session information placed at any virtual machine. In other words, the session is maintained on the Web application regardless of the sticky function of the load balancer 600.

The information processing system of the second embodiment distributes the session information over the virtual machines on the execution servers 100, 200 and 300 using the KVS technique, and increases an access speed to the session information (as described in detail below).

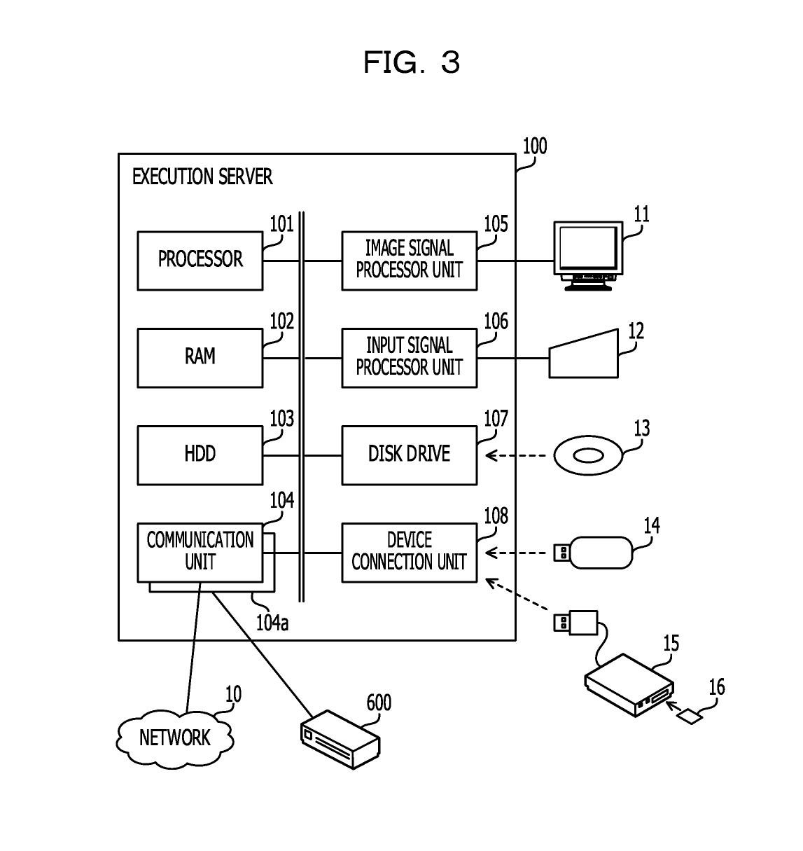

FIG. 3 illustrates a hardware configuration of the execution server 100. The execution server 100 includes a processor 101, a RAM 102, an HDD 103, communication units 104 and 104a, an image signal processor unit 105, an input signal processor unit 106, a disk drive 107, and a device connection unit 108. These elements are coupled to a bus of the execution server 100. Each of the execution servers 200 and 300, the storage server 400, the management server 500, and the clients 700 and 700a also includes elements similar to those of the execution server 100.

The processor 101 controls an information process of the execution server 100. The processor 101 may be one of a central processing unit (CPU), a micro processing unit (MPU), a digital signal processor (DSP), an application specific integrated circuit (ASIC), a field programmable gate array (FPGA), and a programmable logic device (PLD). The processor 101 may also be a combination of at least two of the CPU, the MPU, the DSP, the ASIC, the FPGA, and the PLD.

The RAM 102 is a main memory of the execution server 100. The RAM 102 stores temporarily at least part of an OS program and application programs. The RAM 102 stores a variety of data for use in the process performed by the processor 101.

The HDD 103 is an auxiliary memory of the execution server 100. The HDD 103 magnetically writes and reads data on a built-in magnetic disk. The HDD 103 stores the OS program, the application programs, and a variety of data. The execution server 100 may include different types of memories, such as a flash memory, and a solid state drive (SSD). The execution server 100 may include a plurality of auxiliary memories.

The communication unit 104 is an interface that communicates with the storage server 400 and the management server 500 via the network 10. The communication unit 104a is an interface that communicates with the execution servers 200 and 300, and the clients 700 and 700a via the load balancer 600. The communication units 104 and 104a may be wired interfaces or wireless interfaces.

The image signal processor unit 105 outputs an image to a display 11 coupled to the execution server 100 in response to an instruction from the processor 101. The display 11 may include one of a cathode ray tube (CRT) display and a liquid-crystal display.

The input signal processor unit 106 receives an input signal from an input device 12 coupled to the execution server 100, and then outputs the received input signal to the processor 101. The input device 12 may include a pointing device, such as a mouse or a touchpanel, and a keyboard.

The disk drive 107 receives a program and data recorded on an optical disk 13 using a laser light beam. The optical disk 13 may include one of a digital versatile disk (DVD), a DVD-RAM, a compact disk read-only memory (CD-ROM), a CD-recordable (CD-R), and a CD-rewritable (CD-RW). The disk drive 107 stores the program and data read from the optical disk 13 onto the RAM 102 and the HDD 103 in response to an instruction from the processor 101.

The device connection unit 108 is a communication interface that connects a peripheral device to the execution server 100. For example, the device connection unit 108 is connectable to a memory device 14 and a reader-writer device 15. The memory device 14 is a recording medium equipped with a communication function for communication with the device connection unit 108. The reader-writer device 15 writes data onto a memory card 16, and reads data from the memory card 16. The memory card 16 is a card-shaped memory medium. For example, in response to an instruction from the processor 101, the device connection unit 108 stores the program and data read from one of the memory device 14 and the memory card 16 onto one of the RAM 102 and the HDD 103.

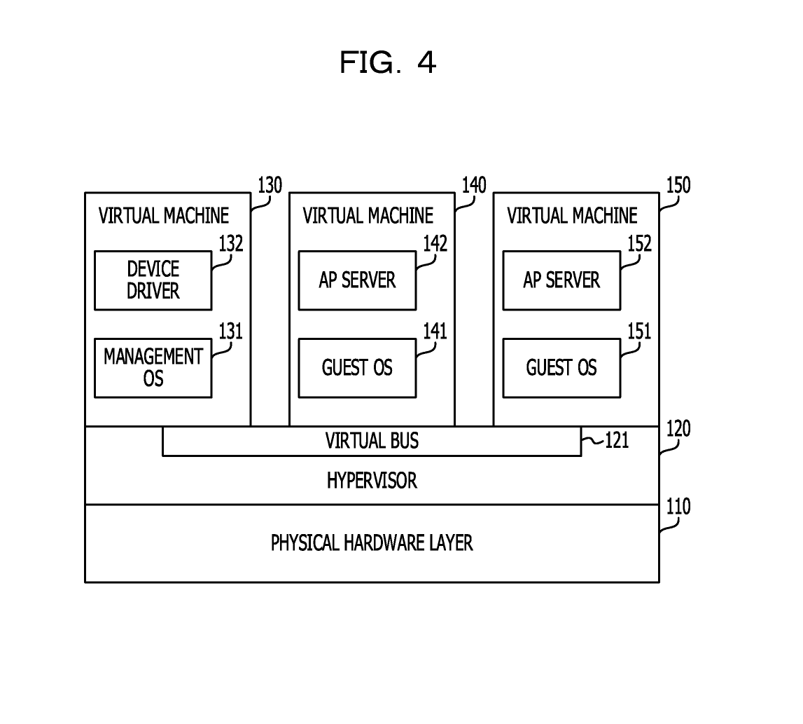

FIG. 4 illustrates an execution example of the virtual machines of the second embodiment. The execution server 100 includes a physical hardware layer 110, a hypervisor 120, and virtual machines 130, 140, and 150. The execution servers 200 and 300 may be identical to the execution server 100.

The physical hardware layer 110 is a set of physical resources including the processor 101, the RAM 102, the HDD 103, the communication units 104 and 104a, the image signal processor unit 105, the input signal processor unit 106, the disk drive 107, and the device connection unit 108.

The hypervisor 120 is software that operates the virtual machines 130, 140, and 150 using the resources at the physical hardware layer 110. The hypervisor 120 allocates the processing power of the processor 101 and the storage area of the RAM 102 to the virtual machines 130, 140, and 150. For example, the hypervisor 120 time-divides availability time of the processor 101 into a plurality of time slices, and then allocates time slices to each of the virtual machines 130, 140, and 150. The hypervisor 120 segments the storage area of the RAM 102 into a plurality of partitions, and then allocates partitions to each of the virtual machines 130, 140, and 150. The hypervisor 120 is also referred to as a virtual machine monitor (VMM).

The hypervisor 120 includes a virtual bus 121. The virtual bus 121 serves as a communication line between the virtual machines 130, 140, and 150.

The virtual machines 130, 140, and 150 run on the execution server 100. The virtual machine may also be called an instance. The virtual machines 130, 140, and 150 individually execute OS's. The virtual machines 130, 140, and 150 may execute the same OS or different OS's.

The virtual machine 130 manages an operation to be performed on input and output devices of the physical hardware layer 110. The input and output devices include the HDD 103, the communication units 104 and 104a, the image signal processor unit 105, the input signal processor unit 106, the disk drive 107, and the device connection unit 108. The virtual machine 130 is referred to as a parent partition. The virtual machine 130 includes a management OS 131 and a device driver 132.

The management OS 131 is an OS running on the virtual machine 130. The management OS 131 provides a use environment of the device driver 132 to the virtual machines 140 and 150 via the virtual bus 121. The device driver 132 is driver software to use the input and output devices of the physical hardware layer 110.

The virtual machines 140 and 150 operate the input and output devices of the physical hardware layer 110 using the device driver 132 on the virtual machine 130. The virtual machines 140 and 150 are referred to as child partitions. The virtual machine 140 includes a guest OS 141 and an AP (application) server 142.

The guest OS 141 communicates with the virtual machine 130 via the virtual bus 121 and operates the input and output devices of the physical hardware layer 110 using the device driver 132. For example, the guest OS 141 communicates with the other virtual machines on the execution servers 200 and 300 via the network 20. The guest OS 141 writes data to and reads data from a resource (storage area) on the HDD 103 allocated to the virtual machine 140.

The AP server 142 is a Web application used by a user. The AP server 142 has a Web server function. The AP server 142 receives a request from the client 700, for example. The AP server 142 executes a transaction operation responsive to the request and then returns execution results to the client 700 (as a response).

Upon establishing a session through a login operation or other operation with the Web browser of the client 700, the AP server 142 attaches a session ID (identifier) to the client 700. The AP server 142 then creates session information in association with the session ID. The session information includes a user ID, a password, and information used in the transaction operation. The session information may include further information as to the transaction operation, as appropriate.

The virtual machine 150 includes a guest OS 151 and an AP server 152. The guest OS 151 is identical to the guest OS 141, and the discussion thereof is omitted herein. The AP server 152 is identical to the AP server 142, and the discussion thereof is omitted herein.

The virtual machines 140 and 150 operate the input and output devices using the device driver 132 provided by the virtual machine 130. An implementation method of the hypervisor 120 is referred to as a micro kernel type. The implementation method of the hypervisor 120 may also referred to as a monolithic kernel type.

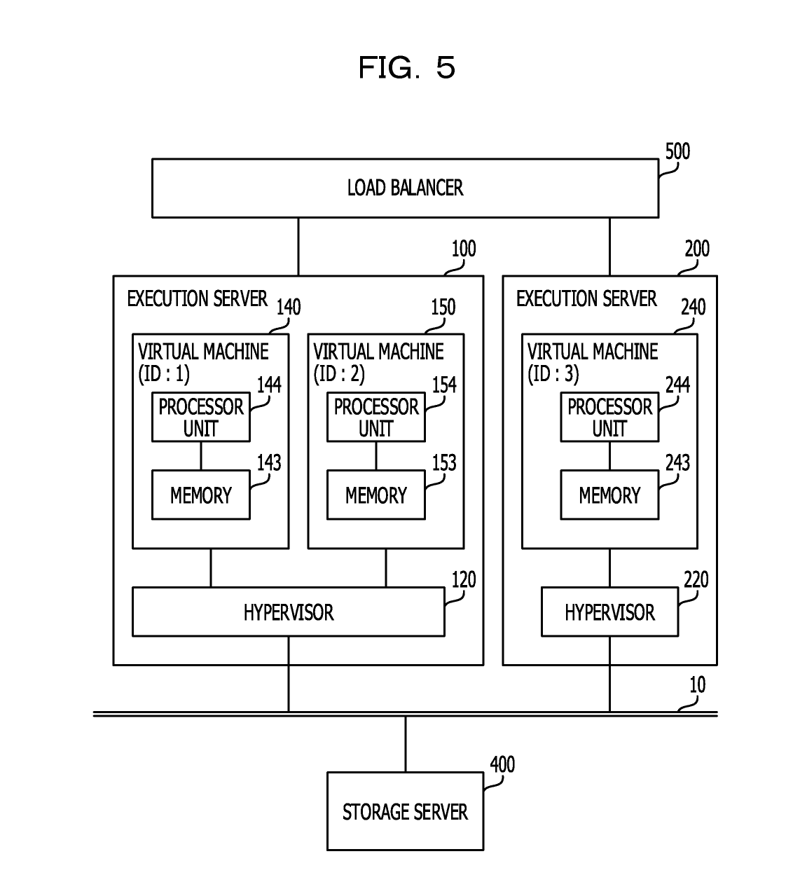

FIG. 5 illustrates a software configuration of the second embodiment. The execution server 100 includes the virtual machines 140 and 150 as previously described. The execution server 200 includes a virtual machine 240. The virtual machines 140, 150, and 240 form a virtual machine group called a cluster. The session information may be shared within the cluster. For example, even if the virtual machine 140 holds no session information therewithin, the virtual machine 140 may still use the session information placed on the virtual machines 150 and 240. The AP servers on the respective virtual machines 140, 150, and 240 distribute the session information to any of the virtual machines in the cluster.

FIG. 5 does not illustrate the execution server 300 and the management server 500 out of the devices coupled to the network 10, and does not illustrate the physical hardware layer 110 and the virtual machine 130 either.

The virtual machine 140 includes a memory 143 and a processor unit 144.

The memory 143 stores a variety of information for use in a process of the processor unit 144. The memory 143 stores the session information created via the KVS technique. More specifically, the memory 143 stores a combination of (key, value)=(session ID, body of the session information) as described above. A combination may also be referred to as a record. A set of a plurality of combinations of (key, value) placed at one virtual machine may occasionally referred to as KVS. The memory 143 stores information to manage the session information as a backup target.

In conjunction with the AP server 142, the processor unit 144 stores on the KVS the session information created when the AP server 142 has established a session with the Web browser. More specifically, when the AP server 142 establishes a new session, the processor unit 144 obtains the session ID and the session information from the AP server 142. The processor unit 144 distributes the obtained session ID and session information to any of the virtual machines using the KVS technique. The key is the session ID and the value is the session information.

When the AP server on each of the virtual machines 140, 150, and 240 operates the session information, the processor unit 144 obtains content of the operation, and then accounts for the content of the operation in the KVS. In response to a request specifying a key from the AP server, the processor unit 144 extracts the session information from the KVS and then supplies the session information to the AP server.

Based on information stored on the memory 143, the processor unit 144 controls a backup operation of the session information on the storage server 400.

The virtual machine 150 includes a memory 153 and a processor unit 154. The virtual machine 240 includes a memory 243 and a processor unit 244. Since the memories 153 and 243 are identical to the memory 143, the discussion thereof is omitted herein. Since the processors 154 and 244 are identical to the processor 144, the discussion thereof is omitted herein.

The virtual machines 140, 150, and 240 are tagged with respective virtual machine IDs unique in the cluster (the virtual machine ID is simply denoted by ID in FIG. 5). The virtual machine ID of the virtual machine 140 is “1”. The virtual machine ID of the virtual machine 150 is “2”. The virtual machine ID of the virtual machine 240 is “3”.

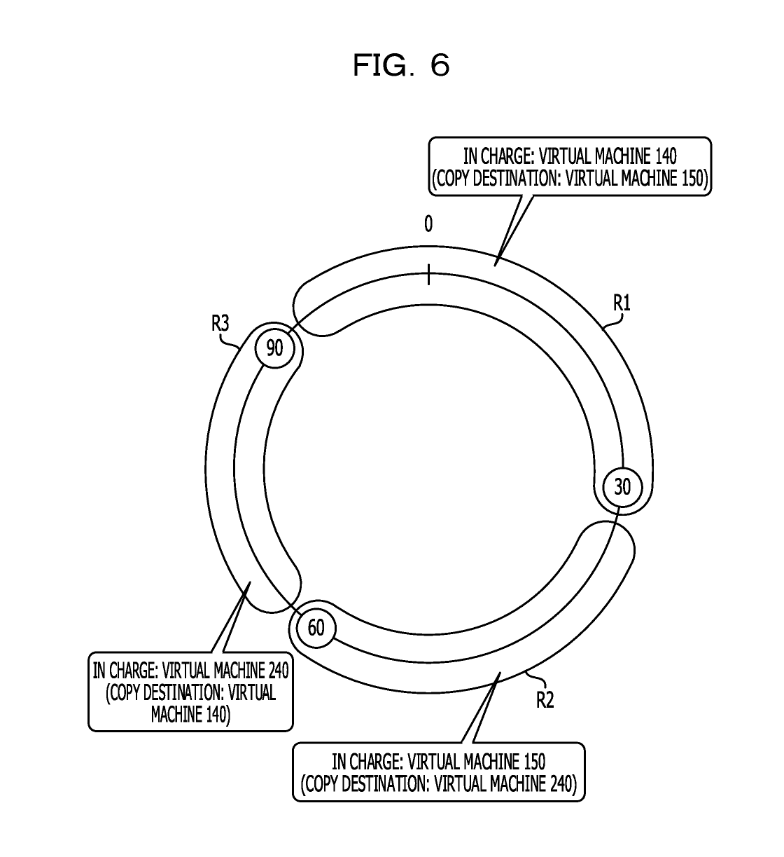

FIG. 6 illustrates an example of an assignment range of a hash value of the second embodiment. The information processing system of the second embodiment uses a method called consistent hashing to determine a placement destination of the key and value. In the consistent hashing, an entire range of the hash values calculated from the key is segmented into a plurality of ranges, and the ranges are allocated to a plurality of nodes. Each node has a responsibility of maintaining the key and value within a range of the hash value for which the node is in charge of. The hash function for use in the consistent hashing is a “hash function that determines the placement destination of the key and value”.

The entire range of the hash values is 0 through 99 in the second embodiment. The hash value “99” is followed by the hash value “0”. The entire range of the hash values is divided into hash value ranges R1, R2, and R3. The hash value range R1 is “0 through 30” and “91 through 99”. The virtual machine 140 is in charge of the hash value range R1. The hash value range R2 is “31 through 60”. The virtual machine 150 is in charge of the hash value range R2. The hash value range R3 is “61 through 90”. The virtual machine 240 is in charge of the hash value range R3.

The processor units 144, 154, and 244 make a copy of key and value placed on one of the virtual machines 140, 150, and 240, and places the copy on another of the virtual machines 140, 150, and 240. In other words, the processor units 144, 154, and 244 hold the same data is held on a total of two of the virtual machines. The redundancy of the key and value is thus increased.

The processor units 144, 154, and 244 determine a virtual machine as a copy destination of a given key and value in accordance with a virtual machine ID. More specifically, from among adjacent virtual machines, the processor units 144, 154, and 244 place a copy of the key and value within the hash value range of a virtual machine having a smaller virtual machine ID at a virtual machine having a larger virtual machine ID. In this case, a copy of the key and value within the hash value range which the virtual machine having the largest virtual machine ID is in charge is placed at the virtual machine having the smallest virtual machine range. The word “adjacent” means that hash value ranges the virtual machines are in charge of are adjacent to each other.

More specifically, a copy destination of the key and value which the virtual machine 140 (virtual machine ID:1) is in charge of is the virtual machine 150 (virtual machine ID:2). A copy destination of key and value which the virtual machine 150 (virtual machine ID:2) is in charge of is the virtual machine 240 (virtual machine ID:3). A copy destination of key and value which the virtual machine 240 (virtual machine ID:3) is in charge of is the virtual machine 140 (virtual machine ID:1). If the placement destination of the key and value is determined by the key, the copy destination is also determined.

Even if the virtual machine 150 shuts down because of a fault, the virtual machine 140 may maintain the session of the Web application by obtaining the copy of the key and value placed at the virtual machine 150 from the virtual machine 240.

The copying of the key and value may be performed each time a new key and value are added, or each time the key and value are updated. If a given key and value are deleted from the KVS, that key and value are also deleted from the KVS at the copy destination.

Information indicating the hash function and the hash value range which a given virtual machine is in charge of is provided to the virtual machines 140, 150, and 240 in advance, and is held on the memories 143, 153, and 243. Information indicating which virtual machine serves as a copy destination of the hash value range of a given virtual machine is also provided to the virtual machines 140, 150, and 240 in advance, and is held on the memories 143, 153, and 243.

A method other than the consistent hashing method of using the key may be employed to determine the placement destination of the key and value. A method other than the method of using key described above may be employed as a method of determining the copy destination of the key and value.

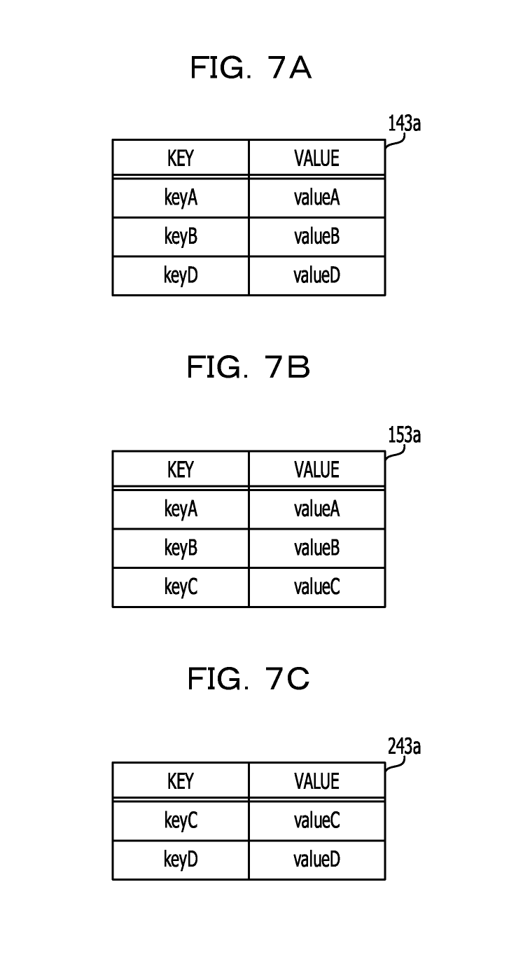

FIGS. 7A, 7B and 7C illustrate examples of the KVS of the second embodiment. FIG. 7A illustrates KVS 143a. The KVS 143a is stored on the memory 143. FIG. 7B illustrates KVS 153a. The KVS 153a is stored on the memory 153. FIG. 7C illustrates KVS 243a. The KVS 243a is stored on the memory 243.

Keys of the KVS 143a, the KVS 143b, and the KVS 243a are session IDs. The value is a body of the session information. For example, information registered on the KVS 143a is (key, value)=(keyA, valueA), (keyB, valueB), and (keyD, valueD). Information registered on the KVS 153a is (key, value)=(keyA, valueA), (keyB, valueB), and (keyC, valueC). Information registered on the KVS 243a is (key, value)=(keyC, valueC), and (keyD, valueD).

In the KVS 143a, the hash value of “keyA” and “valueA” is included in the hash value range R1 which the virtual machine 140 is in charge of. The hash value of “keyD” is included in the hash value range R3. In other words, (key, value)=(keyD, value D) is a copy of the key and value placed at the virtual machine 240.

In the KVS 153a, the hash value of “keyC” falls within the hash value range R2 which the virtual machine 150 is in charge of. The hash values of “keyA” and “keyC” fall within the hash value range R1. In other words, (key, value)=(keyA, valueA), and (keyC, valueC) are copies of the key and value placed at the virtual machine 140.

In the KVS 243a, the hash value of “keyD” falls within the hash value range R3 which the virtual machine 240 is in charge of. The hash value of “keyC” falls within the hash value range R2. In other words, (key, value)=(keyC, valueC) is a copy of the key and value placed at the virtual machine 150.

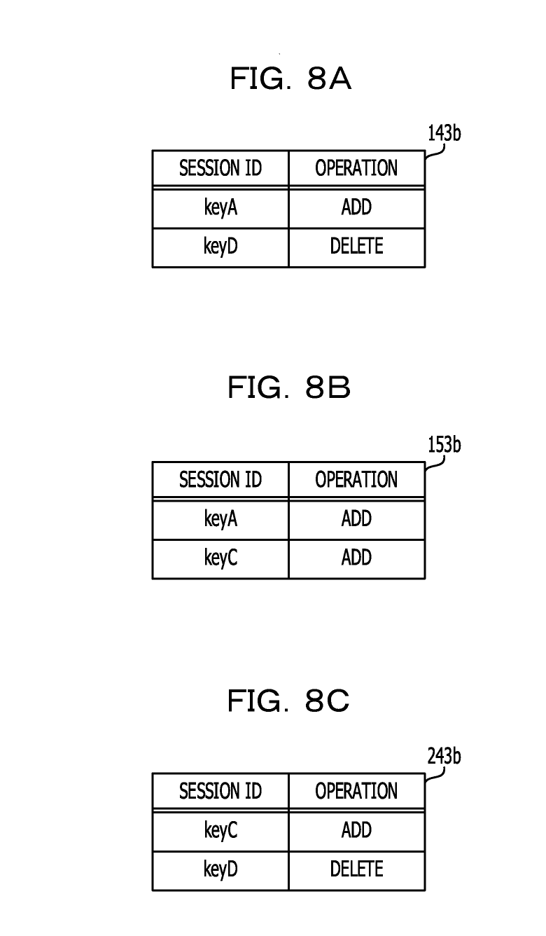

FIGS. 8A, 8B and 8C illustrate examples of management tables of the second embodiment. FIG. 8A illustrates a management table 143b. The management table 143b is stored on the memory 143. FIG. 8B illustrates a management table 153b. The management table 153b is stored on the memory 153. FIG. 8C illustrates a management table 243b. The management table 243b is stored on the memory 243.

The management tables 143b, 153b, and 243b are logs that record operation content performed from the completion of a previous backup operation on the KVS 143a, the KVS 153a, and the KVS 243a. The management tables 143b, 153b, and 243b include items for the session ID and operation. Session ID's are registered in the item of the session ID. Operation content on the key and value, such as add or delete, is registered in the item of the operation.

Information registered on the management table 143b includes “keyA” at the session ID, and “ADD” at the operation. This means that addition or update has occurred on the key and value of key “keyA” in the KVS 143a and the KVS 153a since the completion of the previous backup operation. More specifically, the operation “ADD” indicates that the backup is to be added or updated on the key and value.

Information registered in the management table 143b are “keyD” at the session ID and “DELETE” at the operation. This means that deletion has occurred on the key and value of key “keyD” in the KVS 143a and the KVS 243a since the completion of the previous backup operation. More specifically, the operation “DELETE” indicates that the backup is to be deleted on the key and value on the storage server 400.

The virtual machines 140, 150, and 240 in this way have held the operation contents performed on keys corresponding to the hash value ranges allocated thereto (including hash value ranges which each virtual machine as a copy source is in charge of) since the completion of the previous backup operation.

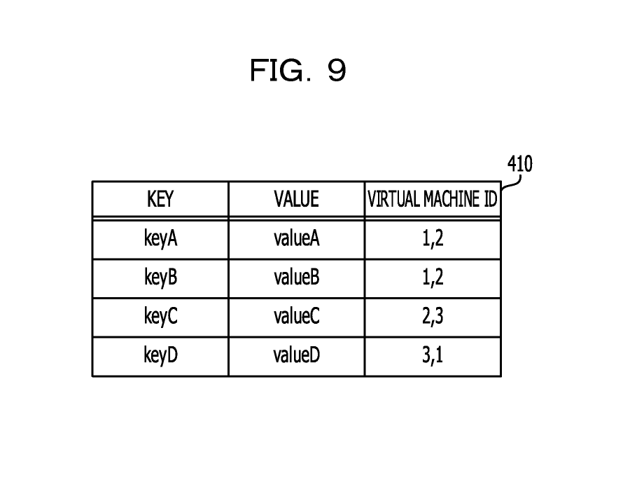

FIG. 9 illustrates an example of a backup table 410 of the second embodiment. The backup table 410 is stored on the storage server 400. The backup table 410 stores backup data of the key and value stored in the KVS 143a, the KVS 153a, and the KVS 243a. The backup table 410 includes items of the key, the value, and the virtual machine ID.

The session ID is registered at the item of the key. The session information is registered at the item of the value. The virtual machine ID of a virtual machine as a backup source is registered at the item of the virtual machine ID. The virtual machine of the backup source may be interpreted as a virtual machine as a restore destination where the backup is restored.

Information registered in the backup table 410 includes “keyA” at the key, “valueA” at the value, and “1, 2” at the virtual machine ID. This means the backup of (key, value)=(keyA, valueA) placed redundantly at the virtual machines 140 and 150.

Data stored in the backup table 410 may be used to restore the data if any virtual machine fails. The backup data may be deleted as soon as the restoration becomes unnecessary. For example, if the session information is deleted from the KVS as a backup source in succession to a logout, the restoration becomes unnecessary. In such a case, the backup information may be deleted from the backup table 410.

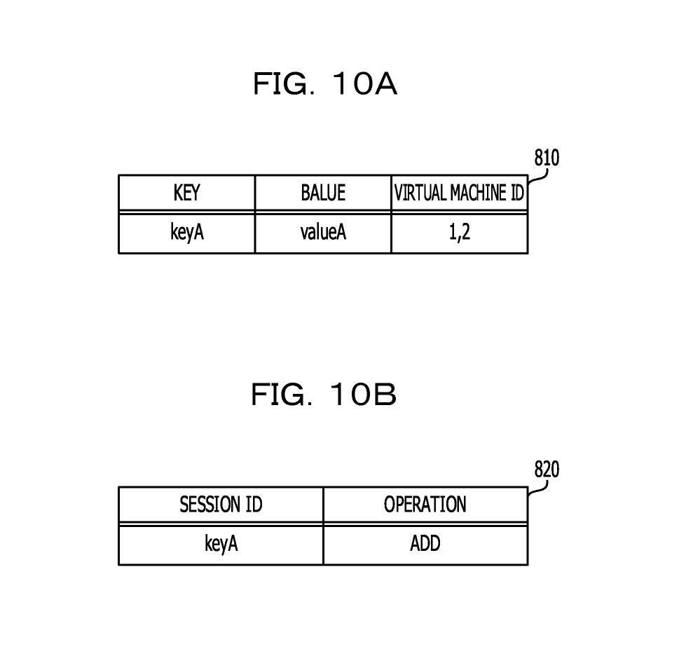

FIGS. 10A and 10B illustrate examples of communication data of the second embodiment. FIG. 10A illustrates an example of communication data 810 that the virtual machine 140 (or the virtual machine 150) transmits to the storage server 400. In a backup operation, the processor unit 144 (or the processor unit 154) creates and then transmits the communication data 810 to the storage server 400. The virtual machine 240 also transmits communication data in the same format as the communication data 810 to the storage server 400.

The communication data 810 includes fields of the key, the value, and the virtual machine ID. The session ID is set in the field of the key. The session information is set in the field of the value. The virtual machine ID of the virtual machine as a backup source is set in the field of the virtual machine ID.

For example, information set in the communication data 810 includes “keyA” as the key, “valueA” as the value, and “1, 2” as the virtual machine IDs. These pieces of information correspond to a record at a first row of the backup table 410. Upon receiving the communication data 810, the storage server 400 registers the record in the backup table 410.

In order to delete a record from the backup table 410, an instruction to delete with the key specified may be simply transmitted to the storage server 400.

FIG. 10B illustrates communication data 820 exchanged between the virtual machines 140 and 150. Communication data in the same format is also exchanged between the virtual machine 140 and the virtual machine 240, and between the virtual machine 150 and the virtual machine 240. The communication data 820 includes fields for the session ID and the operation.

A session ID (key) as a backup target at a next backup operation is set in the field of the session ID. An operation content of the key and value indicated by the session ID (key) performed from the completion of the previous backup operation is set in the field of the operation.

The processor unit 144 may now add the key and value of the key “keyA” to the KVS 143a, for example. The processor unit 144 then notifies the virtual machine 150 as a copy destination of the addition, and places the key and value on the virtual machine 150 as well. For example, the processor unit 144 transmits to the virtual machine 150 the communication data 820 together with a copy of generated session information. Optionally, the processor unit 144 may transmit the communication data 820 to the virtual machine 150 at a timing different from the timing of the transmission of the copy of the session information. The processor unit 144 does not transmit the communication data 820 related to the key “keyA” to the virtual machine 240 that is not the copy destination.

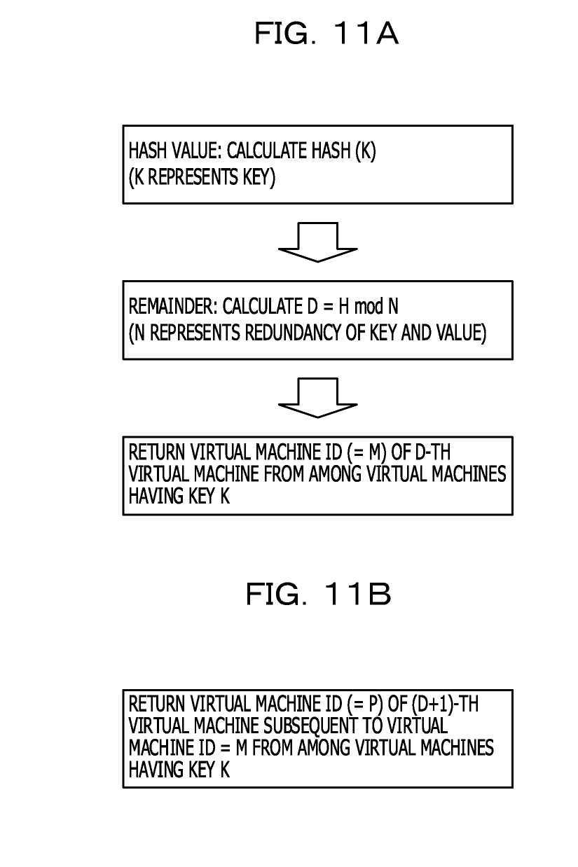

FIGS. 11A and 11B illustrate a processing example of the function of the second embodiment. FIG. 11A illustrates a function Select. The argument of the function Select is K (K may be a character, a character string, a value, a value string, or the like). K is the key of the key and value. The function Select returns M (M may be a character, a character string, a value, a value string, or the like) in response to the key. M is a virtual machine ID. For example, the function Select determines M as described below.

A hash value H=Hash (K) is calculated using a hash function Hash. For example, H is an integer equal to or above 0. A remainder D (D is an integer equal to or above 0) is determined by dividing the hash value H by a redundancy N of the key and value (N is an integer equal to or above 2). More specifically, calculation of D=H mod N is performed. A virtual machine ID of a D-th virtual machine from among virtual machines in charge of the key K is returned as M.

Here, “D-th” means the position of a virtual machine ID in the ascending order. For example, the virtual machines 140, 150, and 240 have the virtual machine IDs “1”, “2”, and “3”, respectively.

In view of the key and value placed on the virtual machines 140 and 150 with a redundancy N=2, D may take values “0” and “1”. In such a case, a “0-th” virtual machine is the virtual machine 140 (with virtual machine ID: 1). A “first” virtual machine is the virtual machine 150 (virtual machine ID: 2).

In view of the key and value placed on the virtual machines 140 and 240 with a redundancy N=2, D may take values “0” and “1”. In such a case, a “0-th” virtual machine is the virtual machine 140 (with virtual machine ID: 1). A “first” virtual machine is the virtual machine 240 (virtual machine ID: 3).

The calculation of the hash function Hash and the calculation of the remainder D may also be referred to as a hash function to calculate a hash value D. The hash function Hash may be “the same hash function to determine the placement destination of the key and value.”

FIG. 11B illustrates a function Next. The arguments of the function Next are K and M. Here, K is an input to the function Select, and M is an output from the function Select. The function Next returns a virtual machine ID (of P) of a next virtual machine, namely, (D+1)-th virtual machine, subsequent to the virtual machine having a virtual machine ID of “M”. P may be a character, a character string, a value, a value string, or the like. If D+1 is larger than a maximum value that D may take, a virtual machine ID of a “0-th” virtual machine is returned.

For example, if the virtual machines 140 and 150 are considered, a virtual machine ID “2” of the virtual machine 150 subsequent to the virtual machine 140 (virtual machine ID: 1) is returned. If the virtual machines 140 and 150 are also considered, the virtual machine 150 may be followed by the virtual machine 140, and then a virtual machine ID “1” may be returned in such a case.

If the virtual machines 140 and 240 are considered, a virtual machine ID “3” of the virtual machine 240 subsequent to the virtual machine 140 (virtual machine ID: 1) is returned. If the virtual machines 140 and 240 are also considered, the virtual machine 240 may be followed by the virtual machine 140, and then a virtual machine ID “1” may be returned.

An update process to update the session information stored on the KVS in accordance with the second embodiment is described below. The following discussion focuses on the process of the processor unit 144. The processor unit 154 and the processor unit 244 operate in the same way.

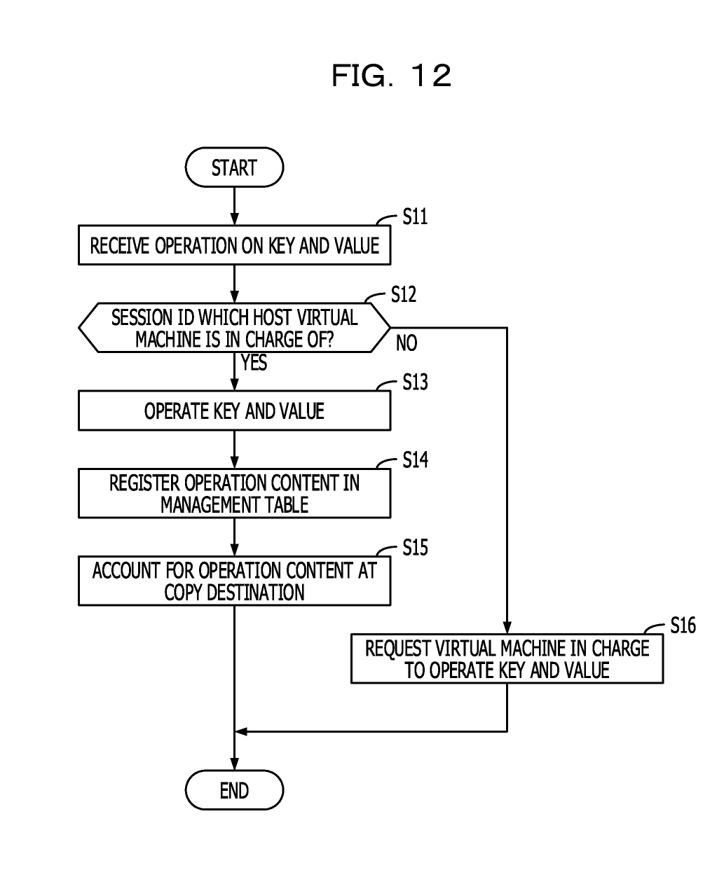

FIG. 12 is a flowchart illustrating a session update process of the second embodiment. The process is described in the order of step numbers of FIG. 12.

S11 The AP server 142 receives an access from a Web browser of the client 700. For example, if a new login authentication is performed on the Web application, the AP server 142 adds session information by issuing a new session ID. If the session information is to be modified in response to a transaction operation, the AP server 142 updates the session information. If a logout operation is performed on the Web application, the AP server 142 deletes the corresponding session ID and session information. The processor unit 144 receives any operation of add, update, and delete of the key and value specified by the session ID (key) from the AP server 142.

S12 The processor unit 144 determines whether a virtual machine that is in charge of holding the received session ID is the virtual machine 140 (host virtual machine). If the virtual machine 140 is in charge of the session ID, processing proceeds to S13. If the virtual machine 140 is not in charge of the session ID, processing proceeds to S16. The processor unit 144 performs the determination operation as described below. More specifically, the processor unit 144 calculates the hash value associated with the session ID (key). The hash function used herein is “the hash function to determine the placement destination of the key and value”. If the hash value falls within the hash value range R1 which the virtual machine 140 is in charge of, the session ID is a session ID which the virtual machine 140 is in charge of. On the other hand, if the hash value does not fall within the hash value range R1, the session ID is not the session ID which the virtual machine 140 is in charge of.

S13 The processor unit 144 operates the key and value stored on KVS 143a. If a key and value are to be added, the processor unit 144 add to the KVS 143a the session information (value) associated with the specified session ID (key). If a key and value are to be updated, the processor unit 144 searches the KVS 143a for a record associated with the specified session ID (key), and then accounts for update content of the session information (value) in the record. If a key and value are to be deleted, the processor unit 144 searches the KVS 143a for a record associated with the specified session ID (key), and deletes the record from the KVS 143a.

S14 The processor unit 144 registers the operation content on the key and value in the management table 143b. An operation item for add and update is labeled “ADD”. An operation item for delete is labeled “DELETE”. The operation content for the key may already be present in the management table 143b. In such a case, the existing record is simply overwritten. In the backup operation, it is sufficient if updated operation content is registered.

S15 The processor unit 144 accounts for the operation in KVS 153a held by the virtual machine 150 as a copy destination of the key and value. In response to an instruction from the processor unit 144, the processor unit 154 adds, updates or deletes a key and value on the KVS 153a. The processor unit 144 may notify the processor unit 154 of the operation content of the key and value using the communication data 820. The processor unit 154 registers in the management table 153b the operation content on the key and value. The processor unit 154 then ends the process.

S16 The processor unit 144 requests the virtual machine in charge of the specified session ID to operate the key and value. The processor unit 144 may then notify the virtual machine of the operation content using the communication data 820. The virtual machine 150 may now receive such a request. In such a case, the processor unit 154 performs operations in S13 through S15. More specifically, the processor unit 154 operates the key and value on the KVS 153a. The processor unit 154 registers the operation content in the management table 153b. The processor unit 154 further accounts for the operation content at the copy destination (the virtual machine 240, for example), and records the operation content (in the management table 243b, for example). The processor unit 154 then ends the process.

The key and value are thus processed. The process of the key and value is described with reference specific key and values as below.

The processor unit 144 may now receive an addition of (key, value)=(keyA, valueA). The hash value of the key “keyA” falls within the hash value range R1. The key and value are those which the virtual machine 140 is in charge of. The processor unit 144 thus adds (key, value)=(keyA, valueA) to the KVS 143a. The processor unit 144 registers a record of the session ID “keyA”, and the operation “ADD” in the management table 143b.

The processor unit 144 notifies the virtual machine 150, as the copy destination of the hash value range R1, of the operation content. Upon receiving the operation content, the processor unit 154 adds (key, value)=(keyA, valueA) to the KVS 153a. The processor unit 154 registers a record of the session ID “keyA” and the operation “ADD” in the management table 153b.

The processor unit 144 may next receive an update of (key, value)=(keyC, valueC). The hash value of the key “keyC” falls within the hash value range R2. The key and value are those which the virtual machine 150 is in charge of, but are not those which the virtual machine 140 is in charge of. For this reason, the processor unit 144 requests the virtual machine 150 to operate the key and value. The processor unit 144 is free from an operation of recording the operation content related to the key “keyC” in the management table 143b.

The processor unit 154 that has been requested to operate the key and value accounts for the update content on (key, value)=(keyC, valueC) on the KVS 153a in the same manner as the processor unit 144 does. In this case, however, the processor unit 154 searches for and updates an existing key and value. The processor unit 154 accounts for the update content in the management table 153b. The processor unit 154 also notifies the virtual machine 240, as the copy destination of the hash value range R2, of the operation content. Upon receiving the operation content, the processor unit 244 similarly accounts for the operation content in the KVS 243a and the management table 243b. The key and value are updated in this way, and are recorded as an update target.

The backup process of the second embodiment is described below. The process described below is performed at a timing when the virtual machines 140, 150, and 240 are individually managed. For example, each of the virtual machines 140, 150, and 240 may start the backup process at any of the following timings.

(1) The backup process is performed each time a specific period of time has elapsed.

(2) The backup process is performed every specific number of updating operations of the key and value in the KVS of the virtual machine.

Alternatively, the backup process may be performed at a timing other than the timings listed above. In the following discussion, the processor unit 144 performs the backup process. The same backup process is applicable to the processor unit 154 and the processor unit 244.

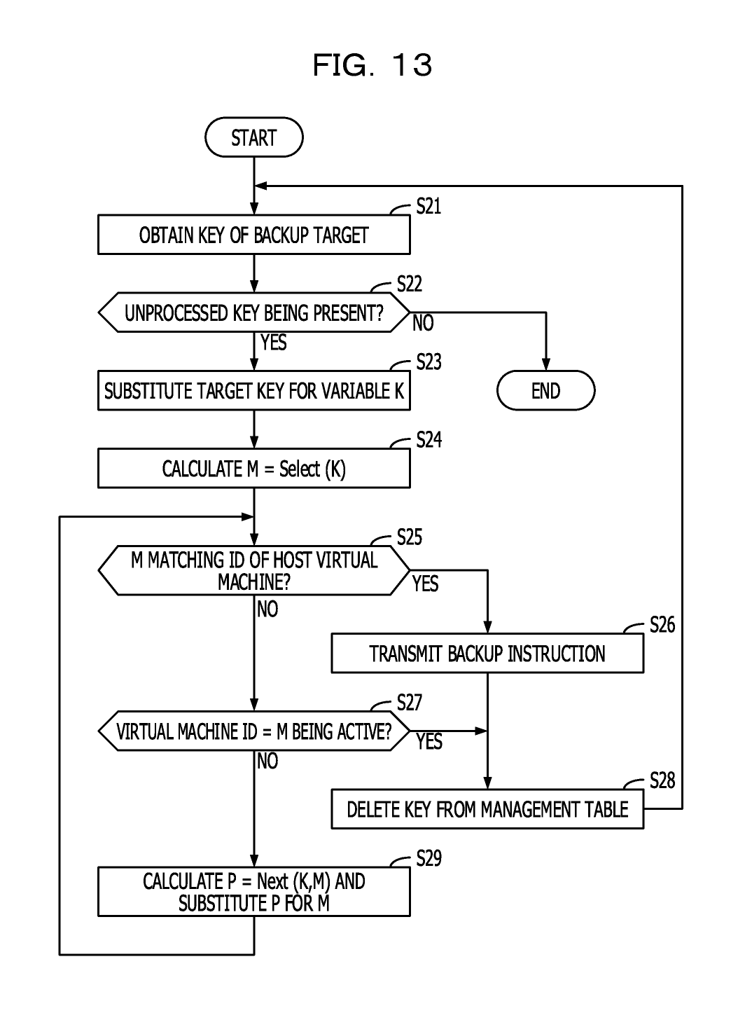

FIG. 13 is a flowchart illustrating the backup process of the second embodiment. The backup process is described in the order of step numbers of FIG. 13.

S21 The processor unit 144 obtains a key as a backup target. More specifically, the key as the backup target is a session ID registered in the management table 143b.

S22 The processor unit 144 determines whether there is an unprocessed key. If there is an unprocessed key, processing proceeds to S23. If there is no unprocessed key, the processor unit 144 ends the process. The unprocessed key refers to a key that has not undergone operations in S23 through S28 yet. More specifically, if at least one session ID (key) is included in the management table 143b, the processor unit 144 determines that there is an unprocessed key. If no session ID (key) is included in the management table 143b, the processor unit 144 determines that there is no unprocessed key.

S23 The processor unit 144 extracts one from the keys determined to be unprocessed in S22, and substitutes the extracted key for a variable K. If there are a plurality of unprocessed keys, the processor unit 144 may extract the largest key or the smallest key, for example.

S24 The processor unit 144 calculates M=Select (K).

S25 The processor unit 144 determines whether the calculated M matches the virtual machine ID “1” of the virtual machine 140 (as the host virtual machine). If the calculated M matches the virtual machine ID “1” of the virtual machine 140, processing proceeds to S26. If the calculated M does not match the virtual machine ID “1” of the virtual machine 140, processing proceeds to S27. For example, if M=Select (keyA)=1, the calculated M matches the virtual machine ID “1”. If M=Select (keyC)=3, the calculated M fails to match the virtual machine ID 1”.

S26 By referencing the management table 143b, the processor unit 144 determines the operation (“ADD” or “DELETE”) responsive to the key extracted in S23 (“keyA”, for example). If the operation is “ADD”, the processor unit 144 extracts a value responsive to the key (“valueA”, for example) from the KVS 143a. The processor unit 144 obtains from the memory 143 the virtual machine ID “1” of the virtual machine 140 in charge of the key, and the virtual machine ID “2” of the virtual machine 150 as the copy destination. The processor unit 144 transmits to the storage server 400 the communication data 810 including the extracted key and value and the virtual machine IDs “1” and “2”. Upon receiving the communication data 810, the storage server 400 stores, on a storage unit such as the HDD, the key and value included in the communication data 810 and information about the virtual machine ID of the virtual machine in charge. If the operation is “DELETE”, the processor unit 144 instructs the storage server 400 to delete the backup record responsive to the key. In response to the instruction, the storage server 400 deletes the record from the backup table 410. Processing proceeds to S28.

S27 The processor unit 144 determines whether the virtual machine (the virtual machine 240, for example) having M (“3”, for example) as a virtual machine ID is active. If the virtual machine is active, processing proceeds to S28. If the virtual machine is not active, processing proceeds to S29. For example, using an Internet control message protocol (ICMP) echo, the processor unit 144 checks whether a virtual machine other than the host virtual machine is active or not. More specifically, the processor unit 144 transmits the ICMP echo to a partner virtual machine. If there is a response, the processor unit 144 determines that the partner virtual machine is active. If there is no response, the processor unit 144 determines that the partner virtual machine is not active.

S28 The processor unit 144 deletes the session ID (key) extracted from the management table 143b in S23. Processing returns to S21.

S29 The processor unit 144 calculates P=Next (K, M). The processor unit 144 then substitutes the calculated P for M. If P=Next (keyC, 3)=1, in other words, even if M=3 immediately prior to this step S29, M becomes M=1 immediately subsequent to this step S29. Processing returns to S25.

The virtual machines 140, 150, and 240 determine in this way whether each of these virtual machines as a host machine is in charge of the backup process of the key and value. One of the virtual machines 140, 150, and 240 is thus caused to transmit one key and value to the storage server 400. The transmission of the key and value to the storage server 400 by a plurality of virtual machines may be avoided in this way. Processing costs and communication costs are reduced more than when multiple communications are performed.

It is contemplated that a given virtual machine performs the backup operation of the key and value not held in its own KVS. In such a case, however, the virtual machine requests another virtual machine holding the key and value to transfer the key and value to the storage server 400. To make such a request leads to an increase in the processing costs and the communication costs.

The virtual machines 140, 150, and 240 thus select as a virtual machine in charge of the backup process from the virtual machines on which the backup target key and value are placed. For example, if (key, value)=(keyA, valueA), one of the virtual machines 140 and 150 is selected as a virtual machine in charge of backing up the key and value. The processing costs and the communication costs remain smaller than when the virtual machine 240 performs the backup process of (key, value)=(keyA, valueA) that is not held thereby.

Since the virtual machines 140, 150, and 240 perform the information process autonomously in this way, the backup process is performed without a device that specifies which virtual machine is to be in charge of the backup process responsive to each key.

The use of the hash function distributes hash values uniformly in response to inputs. For example, a hash value calculated by the hash function Hash becomes one of the values consecutively appearing within a value range. The probability of occurrence of the remainder D resulting from dividing the hash value by the redundancy N is expected to be distributed uniformly. The responsibility of the data storage is substantially uniformly shared among a plurality of virtual machines. For this reason, a process load involved in the data storage is shared substantially uniformly among the plurality of virtual machines with the same data placed thereon. As previously described, the remainder D is also referred to as a hash value in this case.

Each of the virtual machines 140, 150, and 240, if not in charge of the backup process, determines the backup process of the key and value is possible or not by determining whether a virtual machine in charge is active. If there is no virtual machine available to perform the backup process, a host virtual machine performs the backup process instead. Failure to perform the backup process on the session ID (key) registered in the management table 143b is thus avoided.

Particular events (1) through (9) described below may be contemplated in the second embodiment. In each event, backup failure may be avoided. Such events are specifically described below.

(1) A new key and value may be added to the KVS in the middle of the backup process. There is a possibility that the new key and value are outside a target of the current backup process. However, the new key and value becomes a target of the next backup process, and no backup failure is thus likely.

(2) A target key and value may be deleted from the KVS in the middle of the backup process. Depending on the timing of the deletion, the reading of the key and value may fail in the backup process. In such cases, the key and value are not transmitted (no problem arises even if the key and value are not transmitted). The backup process is designed to be continuously performed.

(3) After it is determined that a virtual machine in charge of the backup process of a given key is active, that virtual machine may malfunction. In such a case, the key and value are not backed up in the current backup process. At a next backup process, another virtual machine backs up the key instead.

(4) After it is determined that a virtual machine in charge of the backup process of a given key is not active, another virtual machine takes a turn to the backup process, and then the virtual machine that has been determined to be inactive may be restored. In such a case, the restored virtual machine backs up the key at the next backup process thereafter. A time interval between the current backup timing and the next backup timing may become shorter. This is because the backup timing is individually managed by each virtual machine. It is however noted that multiple backup is not supported.

(5) The restored virtual machine may start the backup process immediately subsequent to the restoration thereof. In such a case, the key and value as a backup target are not present in the KVS of the restored virtual machine. The virtual machine is unable to perform the backup process. The restored virtual machine thus restores the key and value from the storage server 400. The restored virtual machine returns a response indicating inactivation in reply to an activation query from another virtual machine until the restoration has been completed. In this way, the backup of the key and value which the restored virtual machine is in charge of is transferred to another virtual machine.

(6) A virtual machine may be added to the cluster. In such a case, the assignment range of the hash value may be modified in the cluster. A key and value within the hash value range of the added virtual machine is transferred from an existing virtual machine to the added virtual machine. In reply to an activation query from another virtual machine, the added virtual machine returns a response indicating that the added virtual machine is not active until the transfer has been completed. The backup process of the key and value which the added virtual machine is in charge of is transferred to another virtual machine.

(7) The number of virtual machines may change in the cluster during the backup process. Results of the function Select and the function Next may also change. Depending on the timing of the change in the number of virtual machines, one key may be delayed to the next backup, or keys may be backed up consecutively by a plurality of virtual machines within a short period of time. However, no backup failure is likely to take place.

(8) A virtual machine may be added during the backup process. A key and value are moved to the added virtual machine. The key and value are deleted from the virtual machine as a source. Even if the virtual machine in charge of the key and value attempts to back up the key, no key is present. In such a case, the virtual machine fails to read the key, and no key is backed up. Although the key and value are deleted from the virtual machine as the source, the backup data remains in the backup table 410 in the storage server 400. This is because the key and value are moved to and held on the added virtual machine. The backup process of the key and value is thereafter performed by the added virtual machine.

(9) A virtual machine may be deleted during the backup process. The key and value previously present in the KVS of the deleted virtual machine is moved to another virtual machine. The key and value may not be a target of the current backup process, but may become a target of the next backup process. No backup failure is thus likely to take place.

In the second embodiment, the key and value are placed at two virtual machine for redundancy purposes. If the key and value are placed at three or more virtual machines for redundancy purposes, multiple backup is still controlled. The number of virtual machines forming clusters may be two or four or more.

The information process of the first embodiment may be performed by causing each of the information processing apparatuses 1 and 2 to execute a program. The information process of the second embodiment may be performed by causing each of the execution servers 100, 200 and 300 to execute a program. The program may be recorded on computer readable recording media (including the optical disk 13, the memory device 14, and the memory card 16).

To distribute the program, a portable recording medium having the program recorded thereon may be supplied. The program may be stored on a storage device of another computer and delivered to the computer from the other computer via a network. The computer may store on a storage device thereof the program recorded on the portable recording medium or the program received from the other computer, and reads the program from the storage device to execute the program. The computer may directly execute the program read from the portable recording medium, or may directly execute the program received from the other computer via the network.

At least part of the information process may be executed using an electronic circuit including one of the DSP, the ASIC, and the PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a program causing a processor to execute a process, the process comprising:
identifying a second virtual machine in charge of storing data onto a storage in accordance with a hash value that is calculated from a key and a hash function, the key corresponding to the data that is to be stored on the storage and is placed on a first virtual machine from among a plurality of virtual machines running in a computer and the hash function commonly used by the plurality of virtual machine;
storing the data on the storage using the first virtual machine when the second virtual machine matches the first virtual machine; and
performing a control operation so that the first virtual machine does not store the data onto the storage when the second virtual machine fails to match the first virtual machine.

2. The storage medium according to claim 1, wherein the method further comprises:
determining whether the second virtual machine is active when the second virtual machine fails to match the first virtual machine;
performing the control operation so that the first virtual machine does not store the data onto the storage when the second virtual machine is active; and
searching for and identifying a third virtual machine that is able to store the data onto the storage in place of the second virtual machine when the second virtual machine is not active.

3. The storage medium according to claim 2, wherein the method further comprises:
performing the control operation so that the first virtual machine does not store the data onto the storage when the third virtual machine has been identified; and
performing the control operation so that the first virtual machine stores the data onto the storage when the third virtual machine has not been identified.

4. The storage medium according to claim 1, wherein the method further comprises identifying the second virtual machine from among the plurality of virtual machines.

5. The storage medium according to claim 1, wherein the method further comprises calculating the hash value in accordance with a number of the of virtual machines.

6. The storage medium according to claim 1, wherein the method further comprises identifying the second virtual machine in accordance with a correspondence relationship between the hash value and the second virtual machine.

7. The storage medium according to claim 6, wherein the method further comprises identifying the second virtual machine in accordance with an association relationship between a range of the hash value and the second virtual machine.

8. The storage medium according to claim 1, wherein the data comprises an identifier that identifies a session and information of the session, and wherein the plurality of virtual machines share the information of the session.

9. A computer that runs a plurality of virtual machines, comprising:
a memory that stores data, placed on a first virtual machine from among a plurality of virtual machines, in association with a key; and
a processor that identifies a second virtual machine in charge of storing data onto a storage in accordance with a hash value that is calculated from a key corresponding to the data and a hash function commonly used by the plurality of virtual machine, stores the data onto the storage using the first virtual machine when the second virtual machine matches the first virtual machine, and performs a control operation so that the first virtual machine does not store the data onto the storage when the second virtual machine fails to match the first virtual machine.

10. An information processing system, comprising:
a storage; and
a computer that stores data onto the storage and runs a plurality of virtual machines,
wherein the computer includes:
a memory that stores data, placed on a first virtual machine from among the plurality of virtual machines, in association with a key; and
a processor that identifies a second virtual machine in charge of storing the data onto the storage in accordance with a hash value that is calculated from the key corresponding to the data and a hash function commonly used by the plurality of virtual machine, stores the data onto the storage using the first virtual machine when the second virtual machine matches the first virtual machine, and performs a control operation so that the first virtual machine does not store the data onto the storage when the second virtual machine fails to match the first virtual machine.
